(19) United States
(12) Patent Application Publication
(10) Pub. No.: US 2026/0057797 A1
(43) Pub. Date: Feb. 26, 2026

(54) AI-INFUSED CURRICULUM CUSTOMIZATION AND COURSE DELIVERY SYSTEM

(71) Applicant: Charlene Walters, MBA, PHD, LLC, Charlotte, NC (US)

(72) Inventor: Charlene Walters, Charlotte, NC (US)

(21) Appl. No.: 19/305,452

(22) Filed: Aug. 20, 2025

Related U.S. Application Data
(60) Provisional application No. 63/685,831, filed on Aug. 22, 2024.

(51) Int. Cl. G09B 7/04; G06F 40/40

(52) U.S. Cl. CPC G09B 7/04; G06F 40/40

(57) ABSTRACT

A technique for generating a recommended/customized course curriculum for a student based on a pre-course survey, user preferences/interests, and course/content selection. The AI-infused curriculum customization and course delivery system includes features such as a virtual instructor or video/audio course host, and automatic feedback. The virtual instructor is generated based on a student-specific course curriculum and is configured to present course modules, receive assignments/exams, and provide feedback to the student. The virtual instructor interacts with the user throughout the course. The system also includes the ability to monitor sensor data from a wearable device and interrupt the presentation of course modules with a wellness tool in response to a triggering event. Additionally, the course delivery system helps the user with time management and includes the ability to synchronize with a digital calendar/device. Data integrity is managed by soliciting real-time feedback which prompts a user to answer questions about their own submissions.

### CROSS REFERENCE TO RELATED APPLICATIONS

This application claims priority to U.S. Provisional Application No. 63/685,831, filed on Aug. 22, 2024. The contents of which are hereby incorporated by reference in its entirety.

### BACKGROUND

The realm of online and traditional education has experienced a significant transformation over the past few years, driven by advancements in technology and shifts in societal needs. The state of the art in developing educational curricula has evolved to incorporate various technological tools and platforms, aiming to enhance the learning experience and accessibility for students across diverse backgrounds. The current landscape of online education is characterized by tools that facilitate a more personalized learning experience, allowing educators to tailor content to individual student needs and learning styles. The use of video conferencing and collaboration tools has also become commonplace, enabling real-time interaction and feedback between students and instructors.

Despite these advancements, the development and delivery of online educational curricula faces several challenges. One of the primary concerns is the need to maintain student engagement in a virtual environment, which lacks the physical presence and social dynamics of a traditional classroom. Another is the inability to personalize course delivery and curriculum development to individually address a variety of students' interests, backgrounds, learning preferences, and goals. Additionally, ensuring accessibility and equity for all students, regardless of their technological capabilities or learning disabilities, remains a significant hurdle. Yet another challenge is the assessment of student performance and the integrity of online examinations and assignment submissions. The shift towards online learning has necessitated the development of reliable and secure methods for evaluating student understanding without the physical oversight typically present in in-person settings. Further, students may leverage AI for completing assignments without adequately understanding the material. Finally, students are facing more mental health and well-being concerns than previous generations, and struggle to deal with time management as well as the stress and overwhelm associated with the modern educational system. Current course delivery and curriculum development platforms fail to address these issues which can negatively impact students' learning experience, quality of life, progress, educational/career outcomes, as well as an institution's academic standards.

### BRIEF DESCRIPTION OF THE DRAWINGS

For a detailed description of various examples, reference will now be made to the accompanying drawings.

FIG. 1 shows a network diagram of an environment in which various embodiments described herein may be practiced.

FIG. 2 is a flow diagram illustrating a technique for configuring a customized course, in accordance with aspects of the present disclosure.

FIG. 3 is a flow diagram illustrating a technique for automatically generating customized courses for a particular student, in accordance with aspects of the present disclosure.

FIG. 4 shows a flow diagram of a technique for providing wellness feedback to a student during a customized curriculum.

FIG. 5 is a flow diagram illustrating a technique for automatically reviewing student submissions, in accordance with aspects of the present disclosure.

FIG. 6 shows an example of a hardware system for implementation of the networked universal code package provider in accordance with the disclosed embodiments.

FIGS. 7-13 show example screens in accordance with one or more embodiments.

### DETAILED DESCRIPTION

The development of online educational curricula/course delivery stands at a crossroads, with immense potential to revolutionize learning but also faced with significant challenges that must be addressed. Embodiments herein propose a novel solution that addresses these challenges, offering a unique and innovative approach to customizing and delivering online and traditional education.

Described herein is an AI-infused curriculum customization and course delivery system/tool that lets students design their own learning. One where the student decides: what to learn based on their interests/career goals and current topics/skills in different fields; what kind of projects to do to pass the course (papers, presentations, research activities, business plans, hands-on projects, or anything else they choose); what their final grade will be based on how many/complex their assignments are (not someone else's opinion); and what the best instruction for their backgrounds/skills is so that they can have a course that fits their needs, interests, and preferences. For example, the same business course may be adapted to suit different types of learners: an entrepreneur, a C-suite executive, a front-line employee, or an undergraduate student. The course may also be customized to their major and the industries that the student cares about: finance, technology, healthcare, fashion, etc.

In some embodiments, the curriculum customization and course delivery system/tools have a video/audio host, or mentor, who greets and helps the student with the course and interacts with the student in real time using text to video/audio. The video/audio host, or mentor, may also help the student reduce their stress by leading them through activities like meditation, yoga, fitness, breathing exercises etc. (depending on what they like). The mentor may encourage confidence and self-care by giving prompts, tips, and mindset nudges. The mentor may remind the student of the purpose and relevance of their learning for their goals (both professional and personal) and make the student laugh and/or cheer the student up with jokes, compliments and/or motivation.

Some embodiments provide a curriculum customization and course delivery system/tool that monitors the student's sleep, fitness, and stress levels (e.g., by using a wearable device like a smart watch) and provide feedback regarding the observations. The system may also assist students with time management by dividing their assignments/projects into parts and allocating time slots on their calendar for the student to keep up. Additionally, some embodiments could also send them prompts to stay on track. Moreover, the curriculum customization and course delivery system/tool permits and/or facilitates the use of generative AI to help students with assignments, related course content, and research, but still assesses their comprehension and learning outcomes by asking questions related to the submission, while recording and analyzing the student's answers via video/audio. Furthermore, the course customization and delivery system/tool may enable a professor/instructor to focus on teaching students live and offering more detailed, personalized feedback on larger course projects and career-related goals, instead of having to deal with tedious course and administrative tasks.

The course delivery platform is configured to provide a virtual host. In some embodiments, the virtual host comprises a virtual (video and/or audio) representation of an instructor, host, guide, or the like, and is configured to guide the student through the custom curriculum. In some embodiments, the virtual host may be deployed by computer code configured to convert text-based course interaction to video and/or audio using one or more artificial intelligence modules. Course interaction may include, for example, course content, mindset nudges, motivational sayings, confidence builders, lectures, assignments, reminders, jokes, fitness, yoga, deep breathing, relaxation activities, overall course navigation and more.

Although the AI-infused curriculum customization and course delivery system/tool is described primarily in the context of higher education or online courses, it should be understood that it can also be leveraged for K-12, adult education, certification, self-improvement courses, and the like.

In the following description, numerous specific details are set forth to provide a thorough understanding of the various techniques. As part of this description, some of the drawings represent structures and devices in block diagram form. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be omitted, or the components may be performed in a different order or even concurrently. In addition, other embodiments may include additional steps not depicted as part of the flow diagram. Further, the various steps may be described as being performed by particular modules or components. It should be understood that the language used in this disclosure has been principally selected for readability and instructional purposes and may not have been selected to delineate or circumscribe the disclosed subject matter. As such, the various processes may be performed by alternate components than the ones described.

Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

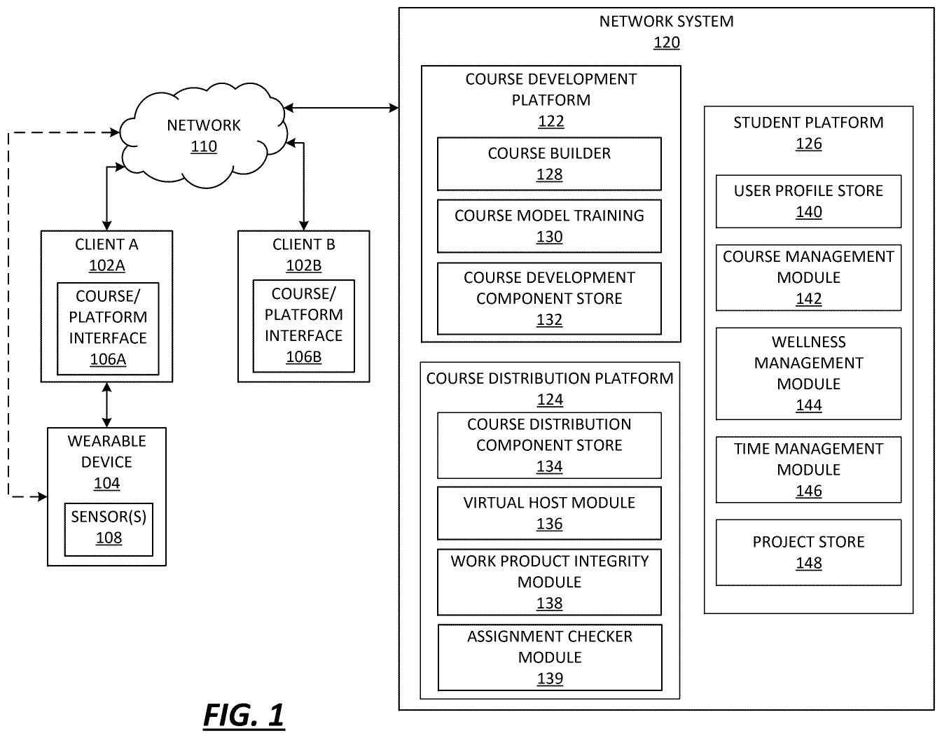

FIG. 1 shows a network diagram of an environment in which various embodiments described herein may be practiced. Techniques described herein provide a system and method for generating and providing an AI-enabled, customizable online course curriculum. The network diagram includes multiple client devices, such as client A 102A and client B 102B, communicably connected to a network system 120 across a network 110. Network 110 may comprise one or more wired or wireless networks, wide area networks, local area networks, short range networks, and the like. Although a particular representation of components and modules is presented, it should be understood that in some embodiments, the various components and modules may be distributed differently.

Clients 102A and 102B (collectively 102) may each be computing devices which may access one or more services to generate or access an online curriculum customization and delivery system and its related courses/curriculum. Client device 102 may comprise a personal computer, a tablet device, a smart phone, laptop computer, mobile device, network device, or any other electronic device which may be used to develop/customize, deliver, or access online courses via a curriculum customization and delivery system/platform. The client computing device 102 can communicate with the one or more network devices 120 using various communication-based technologies, such as Wi-Fi, Bluetooth, cable connections, satellite, and the like. Each client device 102 may include a course/platform interface, such as course/platform interface 106A and course/platform interface 106B, which may be used to access the resources of network system 120. In some embodiments, the course/platform interface may be hosted by the corresponding client device. Alternatively, the course/platform interface may be a web-based interface accessible by a web browser or other application on the client device. The client devices 102 may be used by various users of the curriculum customization and course delivery system, including curriculum developers, students, users, and the like. To that end, course interface 106 may be used to access course development platform 122 on the network system 120 in order to build or maintain a particular academic and/or self-improvement course. Similarly, client devices one or two may be used by students to access student platform 126, or course distribution platform 124.

Network system 120 may be composed of one or more network devices on which the various course customization and delivery systems and/or tools may be hosted. For example, network system 120 may include one or more servers, network storage devices, and the like. Network system may be hosted, for example, on a cloud service, such as Google Cloud Platform (Google is a registered trademark of Google LLC), Amazon Web Services (Amazon Web Services is a registered trademark of Amazon Technologies, Inc.), etc.

Network system includes various components for generating and providing AI-enabled personalized course content. For example, a course development platform 122 may be provided which is configured to provide tools for generating, or maintaining, personalized academic and/or self-improvement courses. In some embodiments, course development platform 122 may include course builder 128, course model training 130, and course development component store 132. Course builder 128 may include program code which allow a teacher, professor, administrator, or the like to develop a module-based course curriculum which can be customizable by a student. In this context, it should be understood that the term “module” refers to a self-contained unit of instruction designed to help a student acquire specific knowledge and/or skills. The course builder 128 may facilitate course development with predefined rules or guidelines, such as particular course parameters. Course builder 128 may also include program code which allows a user to choose their own course topic (unlimited in number and scope), subtopic preferences, and design their own course.

Course model training 130 may be used to train one or more computer models which can be used to provide the course, course content (lectures, assignments, related resources, quizzes, exams, etc.), customization, and delivery. The model or models can be trained for a particular course generated by the course builder. As an example, a model may be trained to provide individualized feedback and suggest additional topics and/or content/resources for study based on user input, feedback, or review. As another example, a model may be trained to provide automatic feedback or scoring the student projects based on the course curriculum.

A possible model is a Text-to-Video and/or Text-to-Audio Generation Model, which can transform textual descriptions or scripts into video and/or audio content. This could use techniques such as video and/or audio generation utilizing machine learning/Large Language Models (LLMs) and/or Generative Adversarial Networks (GANs). According to one or more embodiments, an LLM/machine learning model or GAN could be leveraged for text generation and then a diffusion model could be used to create the audio or video from the generated text. The model could be trained to produce video and/or sequences that depend on the input text, where the text provides direction on what should be shown in the video and/or read via audio. The model can also be used for video/audio Editing and Composition. After the system has created the basic video/audio content, it could apply more algorithms or tools for editing and composing the video/audio, such as video/audio editing algorithms to cut, combine, or improve the generated video/audio sequences, or composition algorithms, to organize different video/audio clips, add transitions, overlays, or effects to make a consistent and captivating video/audio presentation. According to some embodiments, the system could be configured to customize the generated videos/audio based on user preferences and input, context, and interaction history.

In some embodiments, course development platform 122 may include course development component store 132 which may hold course components as the course is being produced. The course development component store 132 may further hold information regarding the course used to train models, for example by course model training 130.

According to one or more embodiments, active courses may be hosted by a course distribution platform 124, from which the courses may be accessed by students, users, and/or professors, instructors, or administrators. The course distribution platform 124 may include a course distribution component store 134, which may consist of modules which can be completed by a student/user as part of the course/curriculum. Course distribution platform 124 may additionally include a virtual host module 136. The virtual host module 136 may be a virtual (audio and/or video) representation of a teacher or professor and/or other avatar or person, and may be configured to greet users, deliver lectures, course content and assignments, help users navigate the system, give instructions, tell jokes, and/or provide motivation, reminders, confidence and mindset boosts, and guide users through activities to increase productivity and reduce stress such as deep breathing exercises, yoga, fitness, and meditation.

The course distribution platform 124 may also include a work product integrity module 138 and assignment checker module (139). The assignment checker model (139) may be configured to analyze students submitted assignments against assignment instructions, topic alignment, and required length/depth of the assignment. The work product integrity module 138 may be configured to analyze students' submitted assignments and generate questions from the submitted text to test the student's understanding. Alternatively, the work product integrity module 138 may leverage pre-determined questions to test the student's understanding and familiarity with the submitted assignment. The student would then answer the generated questions via video or audio and the system, or AI model, would then assess whether or not they understood and/or were familiar with the material.

As part of this analysis, a Large Language Model/Natural Language Processing and/or machine learning could extract key information from the text responses submitted by the students. This could involve tasks like keyword extraction, text summarization and named entity recognition to identify important concepts and topics within the responses. Then, it would generate questions based on the extracted information. This would involve question generation where questions are automatically generated from the text input of the user and/or predetermined by specified parameters. In some embodiments, computer vision could be used to analyze the student users' responses to the generated questions. Computer vision algorithms might be used to detect facial expressions, gestures and other audio or visual cues of the student that could indicate the user's understanding. The model could also use facial and/or audio recognition to make sure that the user responding to the questions is the same person who submitted the text initially. According to some embodiments, a Large Language/machine learning model may be trained to assess the students' learning based on their video and/or audio responses, looking for assignment/content familiarity, coherence, accuracy, and/or depth of understanding. Alternatively, the model could be trained using data labeled by humans who would assess the quality of responses and/or leverage reinforcement learning where the model receives feedback on its assessments and adjusts them accordingly.

Network system 120 may also include a student platform 126, which may provide tools to students using the courses provided on the course distribution platform 124. In some embodiments, the various tools and resources provided in the student platform 126 may be specific to particular courses for which the student is enrolled. Additionally, or alternatively, the student platform 126 may include tools and resources which allow a student to enroll and/or interact with one or more courses and to access other tools/resources on the course delivery platform. To that end, student platform 126 may include a user profile store 140. According to one or more embodiments, the user profile store 140 may be used to store personal information, preferences, and the like for a user of the system. For example, students may complete a pre-course survey to gather information which may be used to customize coursework. Example user data gathered during the pre-course survey may include:
Name
Age
Gender
Major
Their level of professional experience
Skills that they want to gain/improve
Where they are from
Hobbies
Interests
Favorite foods, sports teams, pastimes
Career and personal goals
Major
What type of student they are
Learning preferences
Level of knowledge (related to the course subject)
When they like to study and overall schedule
Level of confidence (self-rated)
What motivates them
Occupation and work experience
Their biggest aspiration
Who is a role model for them
Favorite celebrities or public figures
What type of music they like
What they really want to learn in the course
Their fitness/health-related goals
What they are passionate about
Their nickname/preferred username
What they like most about themselves
What they want to improve about themselves
Whether they enjoy meditation, yoga, deep-breathing exercises, etc. for stress reduction
When they feel most overwhelmed
What industries are they most interested in

The student platform 126 may additionally include a course management module 142. The course management module 142 may be used to sign up for, access, customize and interact with courses provided on the course distribution platform. In some embodiments, the student can select from a set of modules based on their own interests to design a custom curriculum for a particular course. As another example, user information, such as data obtained during the pre-course survey, may be used to provide or suggest a set of modules for a particular course. In some embodiments, courses can be further customized. For example, the course management module 142 may enable a user to choose or create their own learning topics and subtopics while staying within course completion parameters. In some embodiments, the user can choose to take a course on any topic they desire without limitations. As another example, the user can choose their grade and/or other completion metric based on the amount or quality of work completed. Further, the system may allow a user to design or choose their own assignments. In some embodiments, the customization may be available because the LLM, or system, has generated, or a teacher or professor has provided, more content than is needed to complete the course in the course distribution platform 124. For example, the course distribution component store 134 may include numerous components for a course, and a student may select a subset of those components to design a custom version of the course. As another example, artificial intelligence or other tools can be used to suggest, modify, or augment course components for a particular user.

In some embodiments, the student platform 126 may include a wellness management module 144. The wellness management module may track cues related to a student's wellness, and provide feedback or exercises to reduce stress. For example, the wellness management module 144 may maintain one or more repositories of jokes, motivation, mindset nudges, and the like. Wellness management module 144 may further be configured to provide exercises such as breathing exercises, fitness activities, meditations, yoga, or the like to reduce stress, and deliver them at key moments of course delivery and interaction. In some embodiments, the wellness management module 144 may be configured to determine the stress state of a user based on biological cues. For example, a wearable device 104, such as a ring, a watch, or other device, may be configured to track biological data such as sleep, heartrate, blood pressure, and the like using sensor(s) 108, and may determine whether a triggering event occurs indicating that, based on the data, the user is in a stress state, or approaching a stress state. In some embodiments, the triggering event may cause the system to provide wellness feedback, for example by a virtual host or other component of the course or platform. In other embodiments, the triggering event may be initiated by a user or through interaction with the course host or platform itself.

The student platform 126 may additionally include a time management module 146. Time management module 146 may be configured to parse a courseload for a particular user into chunks. The time management module 146 may be configured to interface with a calendar application on the user's device, such as client device 102, to provide calendar entries, tasks, reminders, and the like for the chunks. In some embodiments, the time management module 146 may set time-related milestones for the course, and integrate a course schedule with other activities and courses, and suggest adjustments as needed to stay on track. In some embodiments, the time management module may also make recommendations for adjusting sleep, relaxation, and rest schedules as needed.

Finally, the student platform 126 may include a project store 148, which is configured to store some or all of the following: completed projects or assignments, quizzes and tests, generated lectures, assignment instructions, related course content/resources and other pertinent material. In some embodiments, project store 148 may additionally be used to track grades, progress toward target grades, feedback, and other data related to the student's progress. Other example performance metrics may include student satisfaction scores, course satisfaction surveys, student retention and engagement rates, university enrollment rates, net promoter scores, student learning outcomes/scores, course/program completion rates, job placement/employment data, percentage of work submitted on time, and/or periodic student mental health and stress assessment scores.

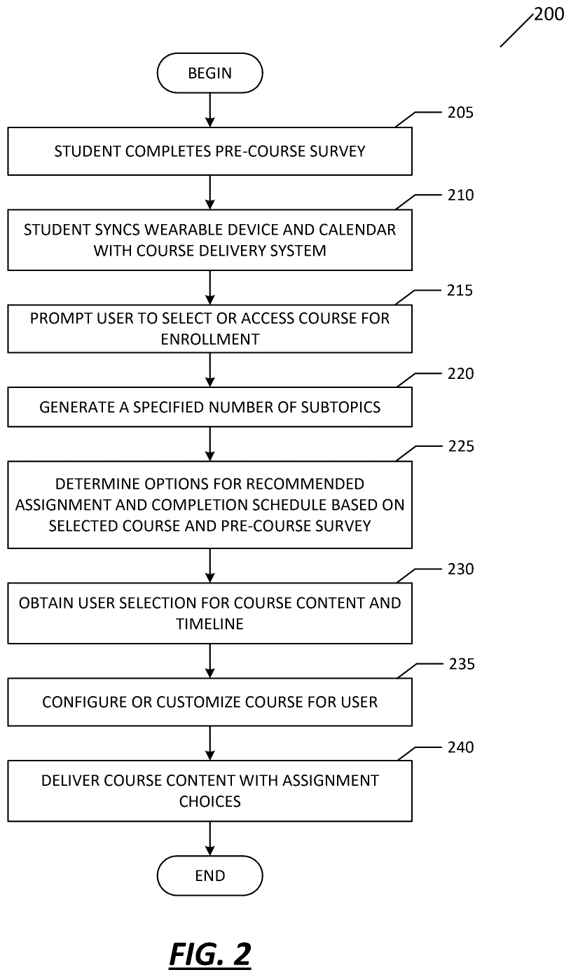

FIG. 2 is a flow diagram illustrating a technique for enrolling in, accessing, and/or customizing a course on the course delivery platform, in accordance with aspects of the present disclosure. It should be understood that the particular flow of the flowchart is used only to exemplify one embodiment. In other embodiments, any of the various components depicted in the flow diagram may be omitted, or the components may be performed in a different order, or even concurrently. In addition, other embodiments may include additional steps not depicted as part of the flow diagram. Further, the various steps may be described as being performed by particular modules or components for purposes of explanation but should not be considered limited to those components.

The flow chart 200 begins at 205, where a student completes a pre course survey. The pre-course survey collects personal and academic information from the student. For example, the survey may ask about the student's name, age, gender, hobbies, interests, goals, major, occupation, skills, learning preferences, confidence level, and more. The system uses the survey data to tailor the course content, topics, assignments, feedback, grade, and schedule to the student's needs and preferences.

At block 210, the student synchronizes a wearable device and a calendar with the course delivery system. In some embodiments, other devices or services may be synchronized, such as a mobile device, a calendar application, or the like. Further, a user may adjust a local device for using the course delivery system. This may include, for example, ensuring permissions are provided to access a camera or microphone, or submitting other consent or permission for using the course delivery system.

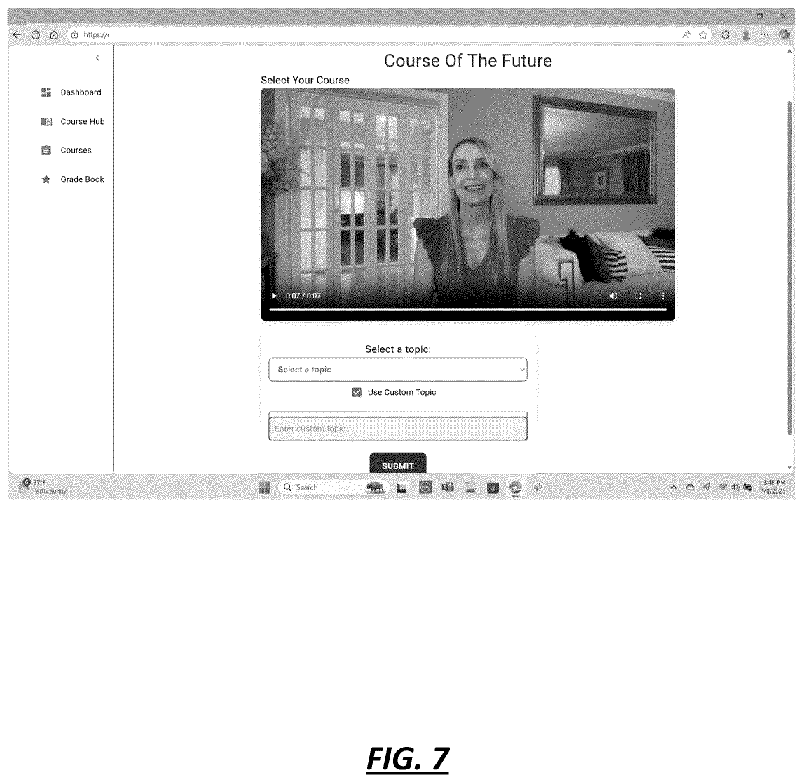

The flow chart 200 proceeds to block 215, where a user is prompted to select/access the course for enrollment. The courses presented to the user may be based on available courses on the course delivery system. Additionally, or alternatively, the courses presented to the user may be based on student authorization or qualification or otherwise determined by administrative parameters. In some embodiments, the user can also choose their own course topic by inputting any topic they choose into an input box. This allows for an unlimited number of options for courses topics. An example of a screenshot of such a prompt is provided in FIG. 7.

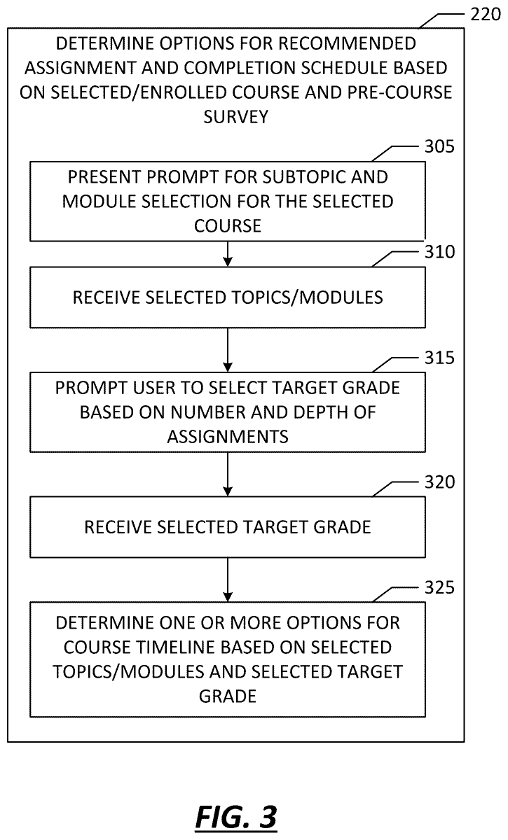

The flow chart 200 proceeds to block 220, where a specified number of recommended, or pre-determined, course subtopics/modules are generated by the system, or LLM. As described further below in FIG. 3, the student chooses a specified number of those subtopics that they are most interested in. The user may also rank the desired subtopics numerically according to preference and course parameters or have the system select randomly from the recommended subtopics. In some embodiments, the specified number and type of subtopics needed to complete the course may be predetermined, and the system may select the appropriate subtopics accordingly.

At block 225, the course options are determined for recommended assignments and completion schedules based on the user's input, administrative parameters, selected course and pre course survey. This step is described further below in FIG. 3. Based on the students' selections in the pre-course survey and additional user input, the system tailors their lessons, course content, and potential assignments for the selected/enrolled course. This customization considers the students' selected topics/subtopics, major, industries of interest, experience level, specific learning choices, and goals. In some embodiments, the system may utilize AI sub-systems such as Course Customizer Student/User Preference Input and Course Design/Assignment Determination Capabilities. These sub-systems may leverage a Large Language Model (LLM)/machine learning, decision trees, collaborative filtering, content-based filtering, and/or a recommendation system to enable the user to choose or create their own learning topics while staying within course completion parameters.

As described in FIG. 3, the options are presented to the user. The options may not only include the course content, but may also include a timeline. In some embodiments, the different options may include different ordering of topics or assignments in the course, different types of assignments or quizzes/exams, different timelines, or the like. In some embodiments, the type of instruction/content may differ across different options and may be selected based on the background or skills of the student derived from the pre-course survey. At block 230, the user selection is obtained by the system for a particular course content option and timeline based on the determined options and user selections in block 225.

The flowchart proceeds to block 235, where the course is configured/customized for the user based on the selections. The course content and timeline may be synchronized with the student's calendar. In some embodiments, this may include determining a schedule for the curriculum delivery and assignment completion based on subtopics or modules in the course, and calendaring schedules and/or reminders with the user calendar.

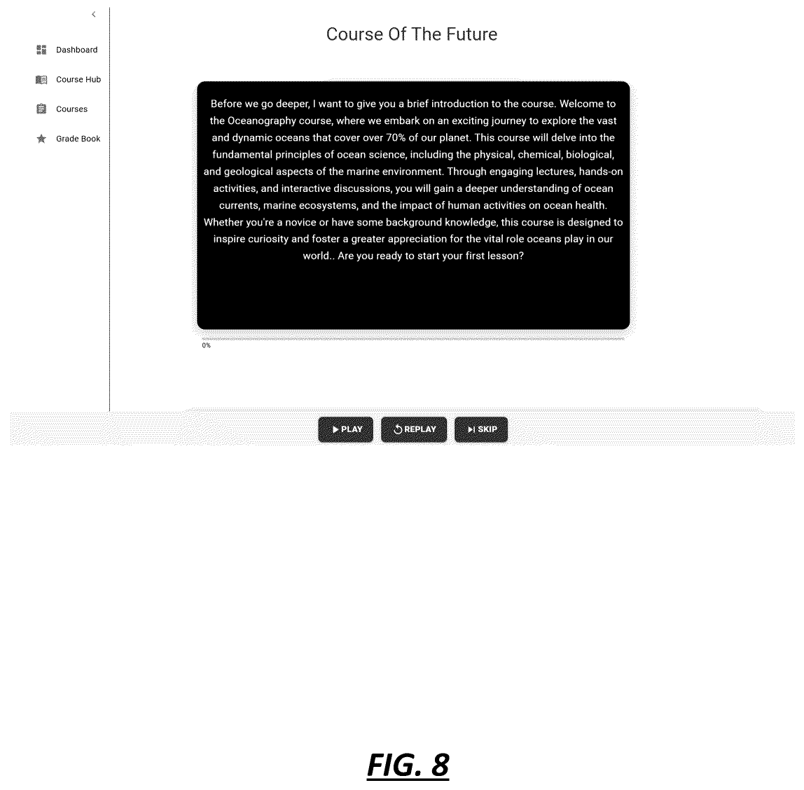

The flow chart 200 concludes at block 240, where the customized course content is delivered to the student. An example of an introductory screen for a course is proved in FIG. 8. The course content may be delivered in accordance with the established schedule/timeline. In some embodiments, during the delivery of the course content, the students may choose the assignment types to be completed. The student may select from projects or assignment types such as papers, presentations, research, hands-on projects, business plans, or other assignment types. In some embodiments, a large language/machine learning model, or other system component, may be trained to assess the student's learning and depth of understanding during the delivery of the course based on the student's video/audio responses and other data described herein. For example, learning models may analyze responses to questions, quizzes, or exams generated based on the course content.

FIG. 3 is a flow diagram illustrating a technique for automatically generating and/or delivering customized courses for a particular student, in accordance with aspects of the present disclosure. In particular, FIG. 3 shows an example flow for determining options for recommended assignments and completion schedules based on the selected course/course components and pre course survey. It should be understood that the particular flow of the flowchart is used only to exemplify one embodiment. In other embodiments, any of the various components depicted in the flow diagram may be omitted, or the components may be performed in a different order, or even concurrently. In addition, other embodiments may include additional steps not depicted as part of the flow diagram. Further, the various steps may be described as being performed by particular modules or components for purposes of explanation but should not be considered limited to those components.

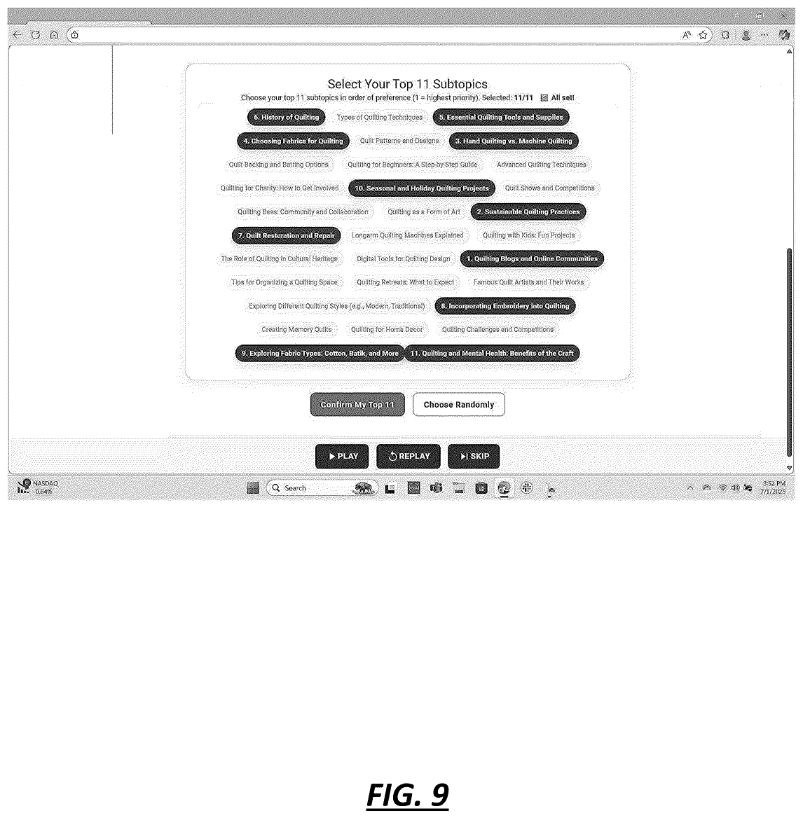

The flow chart begins at block 305, where a prompt is presented for subtopic and module selection for the selected or enrolled course. An example of screenshot of such a prompt is provided in FIG. 9. According to some embodiments, users can choose a subset of a set of modules/subtopics designed for a particular course and/or generated by AI. For example, a student may be asked to select a predefined number of modules/subtopics they find the most appealing or relevant. Other options which may be presented to the user include course content, in which the modules are tailored, for example by one or more AI models, to align with a user's industry, major, level of experience, goals, or the like. At block 310, the selected topics as modules are received.

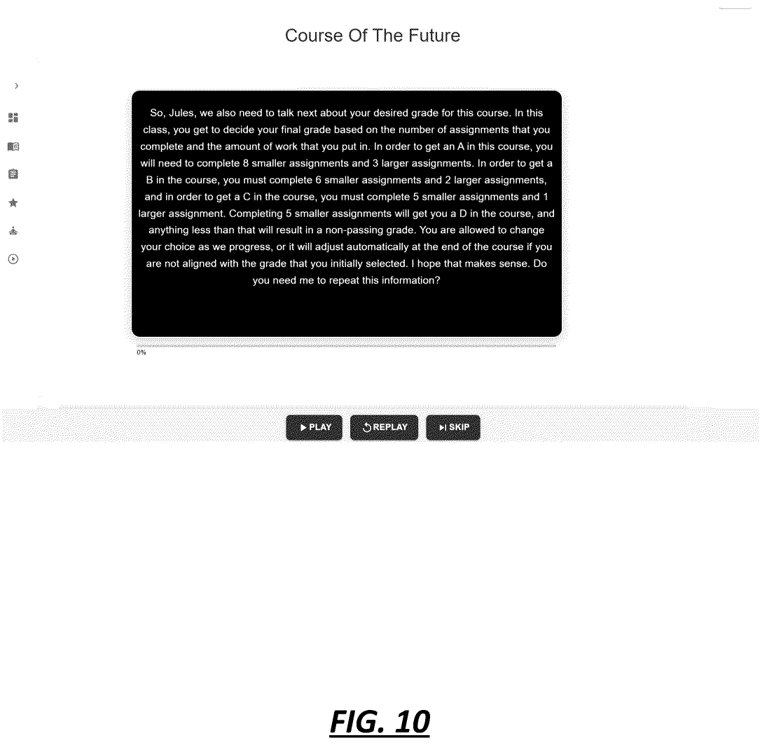

The flowchart proceeds to block 315, where user is prompted to select a target grade or other completion metric based on a number and depth of assignments. The user is presented with options for choosing their desired grade for the course (A, B, or C) or some other completion metric related to course length and/or other parameters. An example of such a prompt is provided in FIG. 10. According to some embodiments, users can choose their desired grade or completion metric at the beginning of the course, which determines the number of assignments and projects they need to complete, a depth of the assignments or tasks they need to complete, or some combination thereof. At block 320, the selected target grade or completion metric is received. Additionally, in some embodiments, the user can change their grade/completion metric selection throughout course delivery. In some embodiments, if the user does not complete their assignments during the allotted time, the system can modify the originally selected grade/metric to match the quality and number of assignment and/or task submissions.

The flow chart concludes at block 325, where one or more options are determined for a course timeline based on the topics and modules selected by the user, as well as the selected target grade and/or another predetermined deadline. Based on the students' selections, the system tailors their lessons, related content, tasks, and potential assignments. This customization considers the students' selected topics, major, industries of interest, experience level, learning choices, and goals. The specific assignment choices may be made by the student throughout the course.

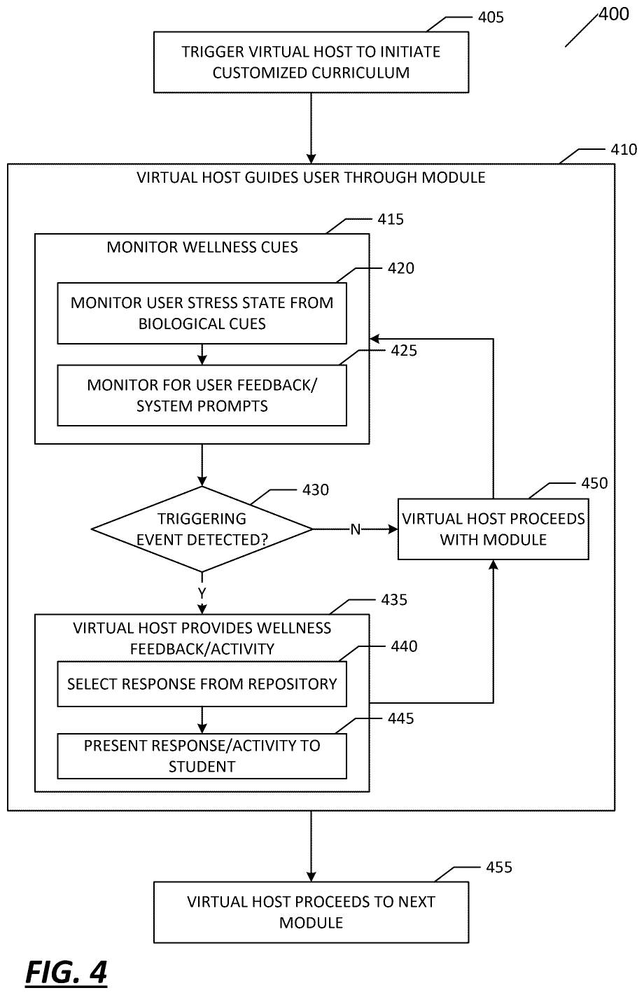

FIG. 4 is a flowchart of a technique for providing wellness feedback and/or wellness activities during custom curriculum/course delivery. It should be understood that the particular flow of the flowchart is used only to exemplify one embodiment. In other embodiments, any of the various components depicted in the flow diagram may be omitted, or the components may be performed in a different order, or even concurrently. In addition, other embodiments may include additional steps not depicted as part of the flow diagram. Further, the various steps may be described as being performed by particular modules or components for purposes of explanation but should not be considered limited to those components.

The flowchart 400 begins at block 405 where the system triggers a virtual host to initiate the customized curriculum. For example, an avatar or other virtual/audio representation of a host or instructor may present an introduction for the course. In some embodiments, the system may ingest predefined or automatically generated text for the course and transform it into a video or audio presentation by an animated character, for example by a machine learning model configured to drive the virtual or audio representation. In other embodiments, customized presentations will be generated by the system, or an LLM, and presented by video or audio, using a person's likeness or voice (host, instructor, or otherwise).

The flowchart 400 proceeds to block 410, where the user is guided through the first module by the virtual host. According to some embodiments, as the user is guided through the model, as shown at block 415, the system is configured to monitor wellness cues. As shown at block 420, monitoring wellness cues may include determining a user stress or fitness/wellness state from biological cues. For example, sensor data of the user may be collected to determine a stress state. This may include, for example, heart rate, blood pressure, facial gestures, or other indicators of a stress response. Monitoring wellness cues also includes, at block 425, monitoring for user feedback and/or responding to system prompts to initiate wellness feedback and/or activities. For example, an interface for the customized curriculum may provide an input component by which a user can indicate a stress state or otherwise indicate a request to receive wellness feedback/wellness activities.

The flowchart 400 proceeds to block 430 where a determination is made as to whether a triggering event is detected. The triggering event may be based on the wellness/fitness cues described above with respect to block 415. If no triggering event is detected, then the flowchart 400 proceeds to block 450, and the virtual host continues to proceed with the module.

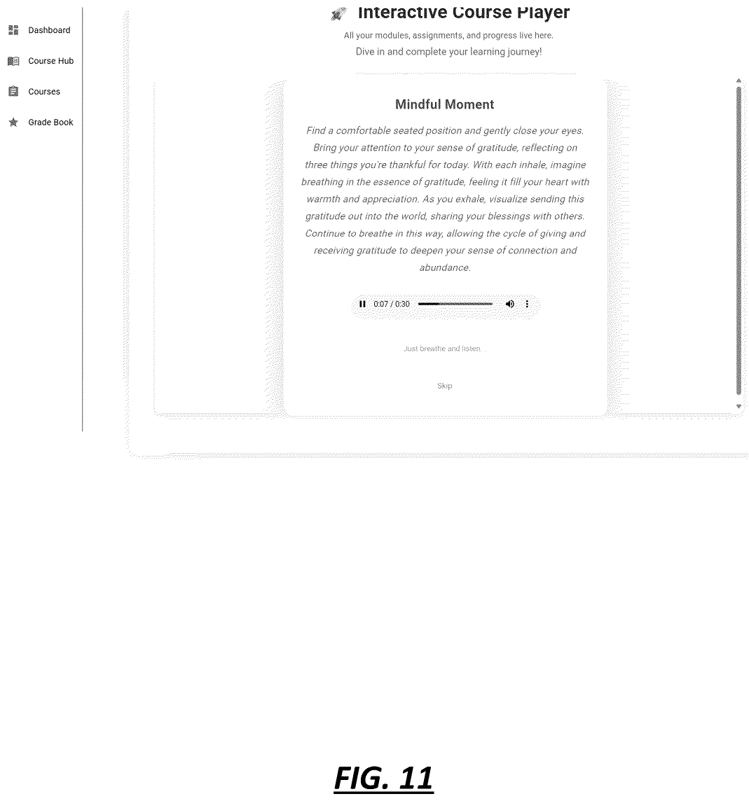

Returning to block 430, if a triggering event is detected, then the flowchart proceeds to block 435. At block 435, the virtual host provides wellness feedback/initiates wellness activities. This may include, for example at block 440, selecting a response from a repository. For example, a data store may include text, videos, or instructions for activities like meditation, yoga, fitness activities, breathing exercises etc. In some embodiments, the repository may include responses that encourage confidence and self-care, tips, and mindset nudges, remind the student of the purpose and relevance of their learning for their goals (both professional and personal), and makes them laugh and cheers them up with jokes and compliments or motivation. An example of providing guided meditation as feedback is shown in FIG. 11. In other embodiments, the repository may also make references to other personalized information from the user's pre-course survey. The particular response may be selected based on various parameters, such as a type of stress cue detected, user preference, predetermined parameters, or the like. The flowchart proceeds to block 445, where the response is presented to the student. In some embodiments, the response is presented by transforming the text from the repository to video and/or audio content of the avatar or virtual host to present the instruction or feedback. After the wellness feedback/activity is presented, the flowchart proceeds to block 450, and the virtual host proceeds within the module. Upon completion of the module, the flowchart 400 concludes at block 455, where the virtual host proceeds to the next module.

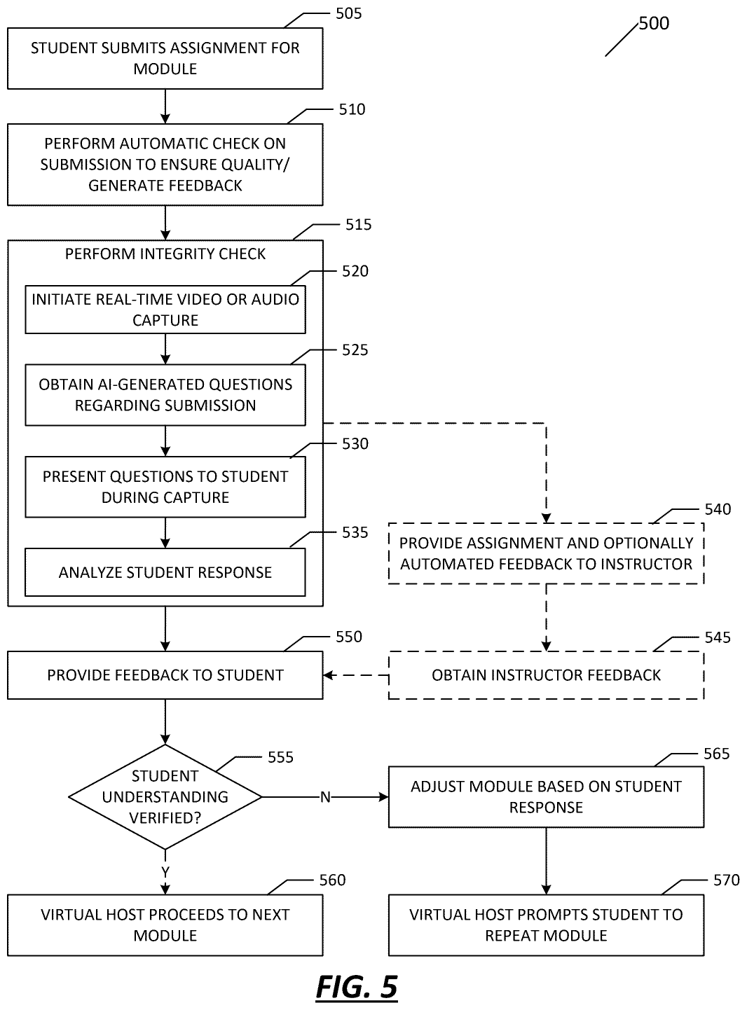

FIG. 5 is a flow diagram illustrating a technique for automatically reviewing student submissions, in accordance with aspects of the present disclosure. It should be understood that the particular flow of the flowchart is used only to exemplify one embodiment. In other embodiments, any of the various components depicted in the flow diagram may be omitted, or the components may be performed in a different order, or even concurrently. In addition, other embodiments may include additional steps not depicted as part of the flow diagram. Further, the various steps may be described as being performed by particular modules or components for purposes of explanation but should not be considered limited to those components.

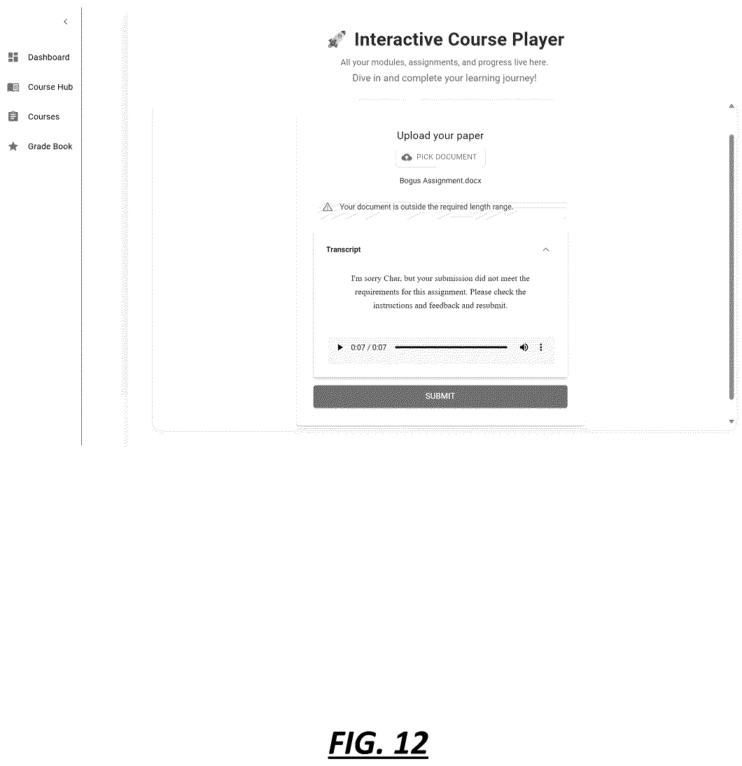

The flow chart 500 begins at block 505, where the student submits an assignment for a particular module. In some embodiments, the assignment may be provided in a predefined form, for example as directed by the guidelines for the module or according to the assignment instructions generated by the system, or LLM. At block 510, an automatic check is performed on the submission to ensure the quality of the assignment and/or generate feedback to enable the user to proceed to the next step in the course flow. In some embodiments, the automatic check may include determining a quality metric for the answers including, but not limited to, an assessment of assignment length (e.g., number of pages for a written assignment) and topic alignment. A large language or machine learning model may be trained to determine a quality metric based on the content of the assignment. In some embodiments, if the user does not pass the quality check, feedback may direct the user to review the assignment/project instructions and resubmit a new assignment, returning to the previous step. An example of a response to failing the quality check is provided in FIG. 12.

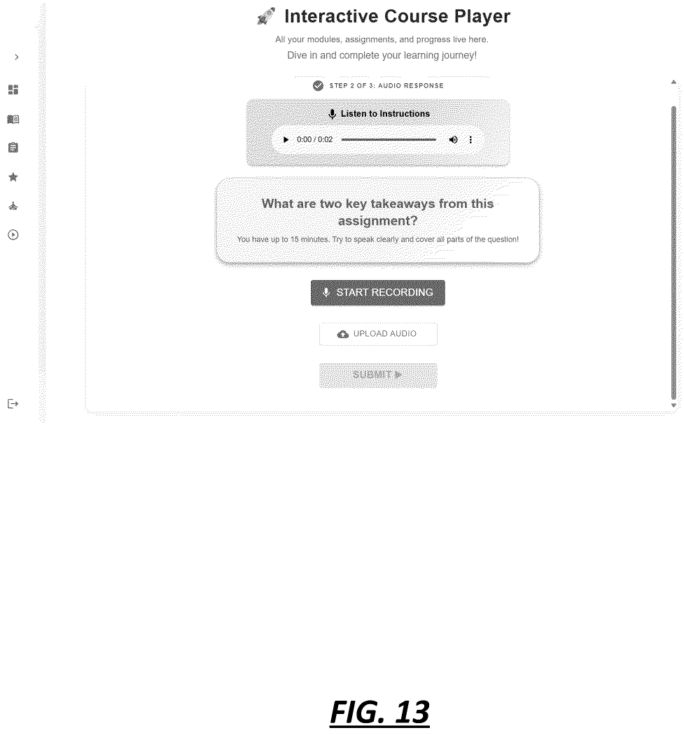

At block 515, an integrity check is performed. The integrity check may include capturing a real time video or audio of the student responding to a question. For example, at block 520, a real time video or audio capture may be initiated. At block 525, AI generated question(s) are obtained regarding the submission. In some embodiments, the AI model generates a question(s) from the submitted text to test the student's understanding and/or leverages a pre-determined question(s). At block 530, the question or questions are presented to a student by the system, or virtual mentor, during the video or audio capture. In some embodiments, the one or more questions may be presented to the student, and the student may upload the response via video or audio. At 535, the student response is analyzed to determine an integrity metric. In some embodiments, the system evaluates the student's video/audio response(s) by converting them into text and comparing them with the assignment content. This process checks if the student's answers align with what was submitted in the assignment. An example of a prompt for the integrity check is provided in FIG. 13. In some embodiments, computer vision is also used to analyze the student's video responses to detect visual cues that could indicate the user's understanding. Optionally, in some embodiments, the integrity metric and the quality metric may be determined in a single step. For example, a large language/machine learning model may be trained to assess the student's learning based on their video/audio responses, looking for familiarity, coherence, accuracy, and depth of understanding. Such assessments are not limited to evaluating assignments, but may be conducted throughout the delivery of the course in the form of questions, quizzes, and exams.

Optionally, the flow chart may proceed to block 540, where the assignment and automated feedback may be presented to an instructor or administrator for human review. In addition, the integrity metric or other information from the integrity check may be provided to the instructor. Then at block 545, instructor feedback may be obtained. For example, the instructor may transmit additional or alternative feedback from a remote device.

The flow chart 500 proceeds to block 550, where feedback is provided to the student/user either in real-time and/or sent to the project store. The feedback may include, for example, a quality metric for the assignment, an integrity metric for the assignment, automatically generated and/or instructor feedback, and the like.

At block 555, a determination is made as to whether student understanding is verified. The student understanding may be verified based on a quality metric and the integrity metric. In some embodiments, the student understanding may further be verified based on instructor feedback. If at block 555, student understanding is verified, then the flow chart proceeds to block 560, and a virtual host proceeds to a next module in the curriculum.

Returning to block 555, if the determination was made that the student understanding is not verified, then the flowchart proceeds to block 565. At block 565, the module may be adjusted based on the student response. For example, one or more machine learning models may be used to identify particular topics or material in the module which the student struggled with understanding. The module may then be adjusted or augmented to include additional material related to the identified topics and/or suggest further review of the assignment submission. The flowchart then concludes at block 570, where the virtual host prompts the student to repeat the module based on the adjustments and/or review the assignment submission and return to block 515 to record a new response.

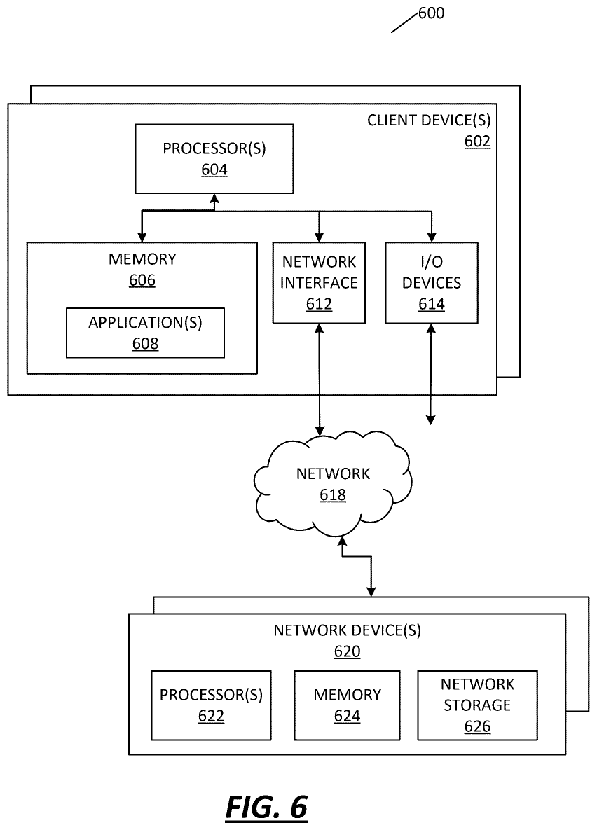

FIG. 6 shows an example of a hardware system for implementation of the AI-infused course delivery/curriculum customization platform in accordance with the disclosed embodiments. FIG. 6 depicts a network diagram 600 including a client computing device 602 connected to one or more network devices 620 over a network 618. Client device 602 may comprise a personal computer, a tablet device, a smart phone, laptop computer, mobile device, network device, or any other electronic device which may be used to develop software programs and/or view, run, compile, execute, etc. software code. The network 618 may comprise one or more wired or wireless networks, wide area networks, local area networks, short range networks, and the like. The client computing device 602 can communicate with the one or more network devices 620 using various communication-based technologies, such as Wi-Fi, Bluetooth, cable connections, satellite, and the like. While shown as a single entity, network 618 may include multiple networks and devices which are not shown for clarity. For example, network 618 may include a wireless local area network accessible from a client device 602 via a wireless access point that is coupled, via a wired portion of the local area network to a router that is in turn coupled to the Internet. The Internet may include various sub-networks and protocols, such as the world wide web (“Web”), along with various versions of these sub-networks and protocols, such as the Web 2.0, Web 3.0, etc., and various hardware components such as servers, switches, routers, bridges, etc. that provide the services for the Internet. Users of the client devices 602 can interact with the network devices 620 to access services controlled and/or provided by the network devices 620.

Client devices 602 may include one or more processors 604. Examples of processors include a central processing unit, processor cores, image processors, microprocessors, graphic processing units, etc., which can execute computer code or computer instructions, for example computer readable code stored within memory 606. For example, the one or more processors 604 may include one or more of a central processing unit (CPU), graphics processing unit (GPU), or other specialized processing hardware. In addition, each of the one or more processors may include one or more processing cores. Processor 604 may include multiple processors of the same or different type. In addition, memory 606 can include one or more of transitory and/or non-transitory computer readable media. For example, multiple processors may be included as processor cores on a single processor package or chip. Multiple processor cores may also be integrated into system on a chip (SOC) packages which often include various peripheral controllers, memories, interfaces, etc. on a single chip. Client devices 602 may also include a memory 606. Memory 606 may each include one or more different types of memory, which may be used for performing functions in conjunction with processor 604. For example, memory 606 may include cache, ROM, RAM, or any kind of transitory or non-transitory computer readable storage device capable of storing computer readable code. Examples of memory 606 include magnetic disks, optical media such as CD-ROMs and digital video disks (DVDs), or semiconductor memory devices. As used herein, non-transitory computer readable storage medium generally refers to computer accessible memory which can maintain data stored thereon for a period of time after power is removed. Memory 606 may store various programming modules and applications 608 for execution by processor 604.

Client device 602 also includes a network interface 612 and I/O devices 614. The network interface 612 may be configured to allow data to be exchanged between client devices 602 and/or other devices coupled across the network 618. The network interface 612 may support communication via wired or wireless data networks. Input/output devices 614 may include one or more display devices, keyboards, keypads, touchpads, mice, scanning devices, voice or optical recognition devices, or any other devices suitable for entering or retrieving data by one or more client devices 602.

Network devices 620 may include similar components and functionality as those described in client devices 602. Network devices 620 may include, for example, one or more servers, network storage devices, additional client devices, and the like. Specifically, network devices 620 may include a memory 624, storage 626, and one or more processors 622. The one or more processors 622 can include, for example, one or more of a central processing unit (CPU), graphics processing unit (GPU), or other specialized processing hardware. In addition, each of the one or more processors may include one or more processing cores. Each of memory 624 and storage 626 may include one or more of transitory and/or non-transitory computer readable media, such as magnetic disks, optical media such as CD-ROMs and digital video disks (DVDs), or semiconductor memory devices. While the various components are presented in a particular configuration across the various systems, it should be understood that the various modules and components may be differently distributed across the network.

Embodiments disclosed herein advantageously use text to video and/or text to audio AI capabilities to provide a virtual host to navigate the learning process. Embodiments are capable of observing, listening, and synchronizing to wearable devices to assess a student's state and evaluate the learning process. The virtual host may provide tips and feedback to students based on the information gathered, as well as walk students through guided meditations, yoga, fitness, and deep breathing exercises. The virtual hose may produce mindset nudges, jokes, reminders, and confidence boosters to a student based on AI decision rules and established user preferences.

Embodiments advantageously leverage AI capabilities to provide curriculum and course customization guided by the student. This includes the potential to pick an overall course topic and multiple subtopics, the types of assignments, and the number and depth of assignments for a desired grade. This has the potential to provide coursework tailored to specific industries, majors, desired learning objectives, professional experience, or selected skills to acquire at any skill level. Embodiments provide a customized course and course delivery system that can generate customized subtopic choices and further provide related resources, articles, videos, and lectures based on the student's choices and background.

Embodiments further leverage AI to verify a student's understanding of submitted work by generating inquiries based on submissions and analyzing responses to the inquiries in conjunction with the information gathered regarding the student. The analysis may analyze a student's response using an AI audio or video capture analysis techniques. Based on the analysis, embodiments may indicate the student has passed the assignment, generate new questions, provide feedback, or make the student resubmit the assignment. These techniques advantageously help prevent plagiarism and a student's ability to use AI to usurp the learning process.

Embodiments further have the ability to determine a timeline to help students with time management during the learning process. This may include dividing assignments and modules of subtopics into sections and/or setting time-related milestones. Embodiments may integrate such a timeline into a student's schedule based on the divisions and the student input, as well as synch such timelines with calendars and suggest adjustments for achieving the desired goals.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A non-transitory computer readable medium comprising computer readable code executable by one or more processors to:
obtain, from user input by a student, results for a pre-course survey related to student background parameters;
receive a selection from the student;
generate a recommended and customized course curriculum for the student based on the results for the pre-course survey and selection, wherein the recommended course curriculum comprises a subset of modules for the course selected in accordance with the selection; and in response to a selection of the recommended course curriculum, generate customized course content based on the selected/recommended course curriculum.

2. The non-transitory computer readable medium of claim 1, wherein the computer readable code to generate the recommended and customized course curriculum comprises computer readable code to:
present a prompt for completion metric; and
select the subset of modules based on the completion metric.

3. The non-transitory computer readable medium of claim 1, wherein the computer readable code to generate the customized course content comprises computer readable code to:
present the customized course content and one or more alternative course content selections to the student.

4. The non-transitory computer readable medium of claim 1, wherein the computer readable code to receive the selection from the student comprises computer readable code to:
present the modules to the student for selection, wherein the modules are predefined, AI-generated, or some combination thereof.

5. The non-transitory computer readable medium of claim 1, further comprising computer readable code to:
cause a schedule for the course to be synchronized with an electronic device associated with the student.

6. The non-transitory computer readable medium of claim 5, wherein the computer readable code to cause the schedule for the course to be synchronized with the user device comprises computer readable code to:
determine a suggested schedule for the course comprising suggested time allocation; and
synchronize the suggested schedule to a calendar application on the electronic device.

7. The non-transitory computer readable medium of claim 1, wherein the computer readable code to generate customized course content comprises computer readable code to:
determine at least one of a learning style and preferences based on the pre-course survey and/or user input; and
generate assignments for the recommended course curriculum based on the at least one of the learning style and preferences, wherein the assignments are generated by a machine learning model trained to generate user-specific assignments based, at least in part, on the learning style and/or one or more student-specific parameters.

8. A system comprising:
one or more processors; and
one or more computer readable media comprising computer readable code executable by the one or more processors to:
provide a course curriculum comprising a plurality of modules;
generate a virtual instructor based on a student-specific course curriculum, wherein the student-specific course curriculum comprises a subset of the plurality of modules, wherein the virtual instructor is configured to:
present the subset of the plurality of modules to a student, wherein each of the course modules comprises one or more assignments,
receive assignments from the user, and
provide feedback to the user based on the received assignments;
generate automatic feedback for the received assignments by one or more machine learning models configured to ingest the one or more assignments and predict a knowledge metric for the student for an associated module; and
monitor sensor data from a wearable device for a triggering event, wherein the presentation of the series of course modules is interrupted by a wellness tool in response to the triggering event being satisfied.

9. The system of claim 8, further comprising computer readable code to:
generate a suggested schedule comprising a task completion timeline for the course; monitor a progress metric for the schedule; and
in accordance with a determination that the progress metric satisfies a correction criterion:
generate a revised course schedule, and
cause the revised course schedule to be synchronized with a calendar application on an electronic device.

10. The system of claim 8, further comprising computer readable code to:
provide additional feedback to a user based on a response to a question by the user.

11. The system of claim 8, wherein the virtual instructor is generated by a text-to-video and/or text-to-audio generation model.

12. The system of claim 8, wherein the virtual instructor is further configured to:
track user engagement with the course;
interact with the user guiding them through the series of course modules;
offer stress management and mindset boosting activities; and
generate content in accordance with the user engagement, user input, and user preferences.

13. The system of claim 8, wherein the sensor data is configured to monitor biometric signals related to stress, sleep, and fitness.

14. The system of claim 8, further comprising computer readable code to:
determine a completion metric for the course curriculum based on a number and quality metric of received assignments and user input.

15. A method comprising:
receiving a completed assignment for a course curriculum module;
applying the competed assignment to a trained network configured to predict a quality metric for the completed assignment;
initiate a real-time feedback process comprising:
generating, by a large language model (LLM) one or more review questions based on the completed assignment and/or pre-supplied question(s), prompting a user to provide real-time responses to the one or more review questions via at least one of video, audio, and text, and
determining an integrity metric based on the real-time responses and/or upload video or audio files; and
determine a score for the course curriculum based on the quality metric and the integrity metric.

16. The method of claim 15, further comprising:
submitting the completed assignment to a remote device for human review;
collecting human review from the remote device; and determining the score for the course curriculum further based on the human review.

17. The method of claim 15, wherein the real-time feedback process comprises:
collecting video or audio data of the user providing the real-time responses.

18. The method of claim 15, further comprising:
in response to a determination that the score satisfies a passing threshold, present a next course curriculum module.

19. The method of claim 15, further comprising:
in response to a determination that the score fails to satisfy a passing threshold, prompt the user to repeat the course curriculum module, resubmit the assignment, or review the assignment submission and repeat the prior step.

20. The method of claim 19, further comprising:
identifying one or more areas of improvement based on the quality metric; and providing an indication of the one or more areas of improvement to the user while prompting them to review their work and/or repeat the prior step(s).
